(19) United States
(12) Patent Application Publication
(10) Pub. No.: US 2026/0120061 A1
(43) Pub. Date: Apr. 30, 2026

(54) METHOD FOR DETECTING WORK LOG ANOMALIES

(71) Applicant: FUSEMACHINES, INC., New York, NY (US)

(72) Inventors: Shiva Ram Godar, Kathmandu (NP); Pramesh Gautam, Kathmandu (NP); Giovanni Patrick Lemus, New York, NY (US); Rakesh Kumar Katuwal, Kathmandu (NP)

(21) Appl. No.: 18/732,291

(22) Filed: Jun. 3, 2024

Related U.S. Application Data
(60) Provisional application No. 63/470,337, filed on Jun. 1, 2023.

(51) Int. Cl. G06Q 10/1091; G06N 20/00

(52) U.S. Cl. CPC G06Q 10/1091; G06N 20/00

(57) ABSTRACT

The present disclosure provides a method for detecting work log anomalies in which a time tracking network collects the user data from the plurality of user devices containing employee work log data, and a text anomaly module uses training data to generate a machine learning algorithm and the text anomaly module and time anomaly module perform machine learning algorithms to determine if an anomaly is contained in the collected data.

### CROSS-REFERENCE TO RELATED APPLICATIONS

The present patent application claims the priority benefit of U.S. provisional patent application 63/470,337, filed Jun. 1, 2023, the disclosure of which is incorporated herein by reference.

### BACKGROUND OF THE DISCLOSURE

### 1. Field of the Disclosure

The present disclosure is generally related to a method for detecting work log anomalies.

### 2. Description of the Related Art

Currently, some issues with contractors or employees are that they input non-work related tasks and charge the company for the time they spent which may lead to improper spending by the company. Also, fraudulent times sheets may lead to a loss of productivity by not contributing to the company's productivity, which can lead to a decrease in overall efficiency. The fraudulent time sheets may be considered fraud, which can lead to legal consequences for the employee. Lastly, improperly filled out timecards are a misuse of company resources in which employees charge for non-work related activities and may be using company resources, such as computers, internet access, or office supplies, for personal use, which can result in additional costs for the company. Thus, there is a need in the prior art to provide a method of detecting work log anomalies.

### SUMMARY OF THE CLAIMED INVENTION

The present disclosure provides a method for detecting work log anomalies in which a time tracking network collects the user data from the plurality of user devices containing employee work log data, and a text anomaly module uses training data to generate a machine learning algorithm and the text anomaly module and time anomaly module perform machine learning algorithms to determine if an anomaly is contained in the collected data.

### BRIEF DESCRIPTIONS OF THE DRAWINGS

FIG. 1 illustrates an exemplary network environment in which a system for detecting worklog anomalies may be implemented.

FIG. 2 is a flowchart illustrating an exemplary method for detecting worklog anomalies.

FIG. 3 is a flowchart illustrating an exemplary method for detecting text-based anomalies.

FIG. 4 is a flowchart illustrating an exemplary method for detecting time-based anomalies.

FIG. 5 is a flowchart illustrating an exemplary method of input collection for anomaly detection.

FIG. 6 illustrates an example of computing system.

FIG. 7 illustrates an example neural network architecture.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

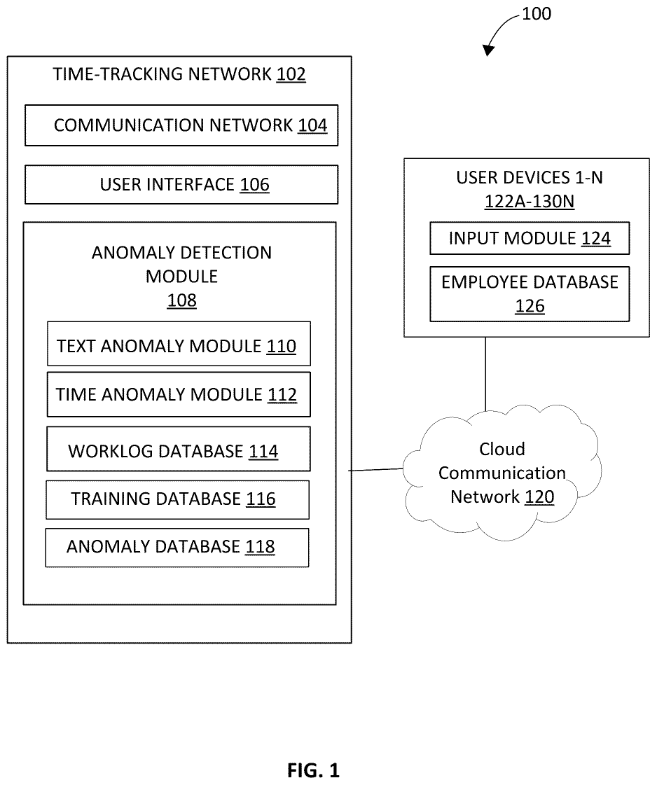

FIG. 1 illustrates an exemplary network environment 100 in which a system for detecting worklog anomalies may be implemented. Time tracking network server 102 may be a project management network server that can track employees' work logs, including the time spent on a task and the task that was worked. The time tracking network server 102 may allow a plurality of user devices 1-N 122 to access or connect to the network to input their work logs. Further, embodiments may include a communication network interface 104, which may be a wired and/or wireless network.

The communication network interface 104, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network interface 104 may allow ubiquitous access to shared pools of configurable system resources and higher-level services that can be rapidly provisioned with minimal management effort, often over the Internet, and relies on sharing of resources to achieve coherence and economics of scale, like a public utility, while third-party clouds enable organizations to focus on their core businesses instead of expending resources on computer infrastructure and maintenance.

Further, embodiments may include a user interface(s) 106, which either accepts users' inputs or provide outputs to the users or perform both actions. In one case, a user can interact with the user interface(s) 106 using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, the user interface(s) 106 may either be implemented as a Command Line Interface (CLI), a Graphical User Interface (GUI), a voice interface, or a web-based user interface.

Further, embodiments may include a anomaly detection module 108, which connects to the plurality of user devices 1-N 122 to collect the data stored in the employee databases 126, which contain the employees' work log data, such as the employee ID, task completed, and time allocated to the task, etc., and stores the data collected from the plurality of employees in the work log database 114 and initiates the text anomaly module 110 and the time anomaly module 112 to determine if there are any anomalies detected with the work log data.

Further, embodiments may include a text anomaly module 110, which begins by being initiated by the anomaly detection module 108. The text anomaly module 110 extracts the data stored in the training database 116. The text anomaly module 110 generates the text model. The text anomaly module 110 filters the work log database 114 on the first employee. The text anomaly module 110 extracts the data from the work log database 114 of the filtered employee. The text anomaly module 110 performs the text model on the extracted data to determine if there are any anomalies with the employees' work log tasks. The text anomaly module 110 determines if there is an anomaly in the employees' work log text data. If it is determined that there is an anomaly contained in the employees' work log text data, the text anomaly module 110 stores the anomaly data in the anomaly database 118. If it is determined that there are no anomalies contained in the employee's work log text data or after the anomalies have been stored in the anomaly database 118, the text anomaly module 110 determines if more employees are remaining in the work log database 114. If it is determined that there are more employees stored in the work log database 114, the text anomaly module 110 filters the work log database 114 on the next employee, and the process returns to extracting the data from the work log database 114. If it is determined that there are no more employees stored in the work log database 114, the text anomaly module 110 returns to the anomaly detection module 108.

Further, embodiments may include a time anomaly module 112, which begins by being initiated by the anomaly detection module 108. The time anomaly module 112 extracts the data stored in the training database 116. The time anomaly module 112 filters the work log database 114 on the first employee. The time anomaly module 112 extracts the data from the work log database 114 of the filtered employee. The time anomaly module 112 performs the time model on the extracted data to determine if there are any anomalies with the employee's work log time allocations. The time anomaly module 112 determines if there is an anomaly in the employee's work log time data. If it is determined that there is an anomaly contained in the employee's work log time data, the time anomaly module 112 stores the anomaly data in the anomaly database 118. If it is determined that there are no anomalies contained in the employee's work log time data or after the anomalies have been stored in the anomaly database 118, the time anomaly module 112 determines if more employees are remaining in the work log database 114. If it is determined that there are more employees stored in the work log database 114, the time anomaly module 112 filters the work log database 114 on the next employee, and the process returns to extracting the data from the work log database 114. If it is determined that there are no more employees stored in the work log database 114, the time anomaly module 112 returns to the anomaly detection module 108.

Further, embodiments may include a work log database 114, which contains the work logs collected from user device 1-N 122 through the process described in the anomaly detection module 108. For example, the database may include the employee ID, which may be a unique identifier for each employee, enabling the system to group the work tasks by employee and track their individual contributions over time. The database may contain the task which describes the nature of the work task completed by the employee. Examples of tasks may be designing a new website, coding a new feature, conducting market research, responding to customer inquiries, team meetings, meetings with other employees, anomalies in the work log, etc. which provides context for the work being performed and allows the time tracking network server 102 to analyze how time is being spent across different types of tasks. The database may include the time spent, displayed in hours, which indicates the amount of time that the employee spent on each task which provides a quantitative measure of productivity and can be used to track progress, estimate project timelines, and allocate resources effectively. In some embodiments, the database may include the date, time, a project or task code, notes from the employee, the priority level of the task for the individual employee, the status of the task or project the task is for, comments or feedback from the employee, if the task was approved or reviewed, etc.

Further, embodiments may include a training database 116 containing the training work log data used by the text anomaly module 110 and the time anomaly module 112 to generate the text and time models, respectively. The training database 116 may contain non-anomalous work log data to generate the models. The training database 116 may contain a plurality of employee IDs, work log tasks, and time allocated to the tasks. In some embodiments, the database may include the date, time, a project or task code, notes from the employee, the priority level of the task for the individual employee, the status of the task or project the task is for, comments or feedback from the employee, if the task was approved or reviewed, etc. In some embodiments, the training database 116 may collect data from the text anomaly module 110 and time anomaly module 112 that has been deemed non-anomalous and can further be used to train future models. In some embodiments, the training data may be a set of input data used to teach a machine learning model, such as the text model or time model, to make predictions or classifications based on that data. For example, the training data may consist of two components, input data, and target data. The input data may be the data that the model will use to make predictions or classifications. The input data can be any type of data that the model is designed to work with, such as images, text, audio, or numerical data. The target data may be the correct output or label associated with each input data point. The target data may be used to train the model to make accurate predictions or classifications based on the input data. In some embodiments, the models may iteratively adjust their parameters to minimize the difference between their predicted and target outputs in the training data.

Further, embodiments may include an anomaly database 118, which contains the anomalies detected by the text anomaly module 110 and time anomaly module 112. The database may contain the employee ID, the anomalous task, or the anomalous time allocated to a task. The database may be used by users of the time tracking network server 102 to review, approve, and track projects or the productivity of employees, etc. In some embodiments, the users of the time tracking network server 102 may display the anomaly database 118 on the user interface 106 to review employee performance, make informed business decisions, adjust processes or timelines, etc. For example, if an employee is producing the same amount of work in half the time as all the other employees, the user of the time tracking network server 102 may interview or discuss that employee's process to determine if their methodology should be adopted business-wide. Another example may be if an employee is performing poorly or not up to the same standard as other employees. The user of the time tracking network server 102 may recommend additional training for the employee.

Further, embodiments may include a cloud communication network 120, which is a distributed network of computers comprising servers and databases. A cloud 120 may be a private cloud 120, where access is restricted by isolating the network, such as preventing external access, or by using encryption to limit access to only authorized users. Alternatively, a cloud 120 may be a public cloud 120 where access is widely available via the Internet. A public cloud 120 may not be secured or may include limited security features.

Further, embodiments may include a plurality of user devices 1-N 122 which may be a desktop computer, laptop computer, tablet, smartphone, other portable computing device, etc. The user device 122 may be used by individuals to access and interact with a software application, data, and other resources hosted on a network or server. A user device 122 may be any device that provides an interface between a user and a computer system or network. This interface may include hardware components such as a display, keyboard, mouse, or touchpad and software applications allowing users to perform tasks and access information. User devices 122 may also include built-in sensors such as cameras, microphones, or GPS modules, enabling the device to collect data and interact with the environment differently. In some embodiments, a user device 122 may also have a unique identifier or address that allows it to be recognized and tracked on a network. This identifier may be a hardware-specific identifier, such as a MAC address, or a software-specific identifier, such as an IP address.

Further, embodiments may include an input module 124, which begins by connecting to the time tracking network server 102. The input module 124 continuously polls for the user inputs. The input module 124 receives the user inputs through the user device 1-N 122. The input module 124 stores the user inputs in the employee database 126. The input module 124 receives a request from the anomaly detection module 108 for the data stored in the employee database 126. The input module 124 sends the data stored in the employee database 126 to the anomaly detection module 108 and returns to continuously polling for the user inputs.

Further, embodiments may include an employee database 126, which contains the inputs collected from the user through the process described in the input module 124 and is sent to the anomaly detection module 108 to be stored in the work log database 114. For example, the database may include the employee ID, which may be a unique identifier for each employee, enabling the system to group the work tasks by employee and track their individual contributions over time. The database may contain the task which describes the nature of the work task completed by the employee. Examples of tasks may be designing a new website, coding a new feature, conducting market research, responding to customer inquiries, team meetings, meetings with other employees, anomalies in the work log, etc. which provides context for the work being performed and allows the time tracking network server 102 to analyze how time is being spent across different types of tasks. The database may include the time spent, displayed in hours, which indicates the amount of time the employee spent on each task which provides a quantitative measure of productivity and can be used to track progress, estimate project timelines, and allocate resources effectively. In some embodiments, the database may include the date, time, a project or task code, notes from the employee, the priority level of the task for the individual employee, the status of the task or project the task is for, comments or feedback from the employee, if the task was approved or reviewed, etc.

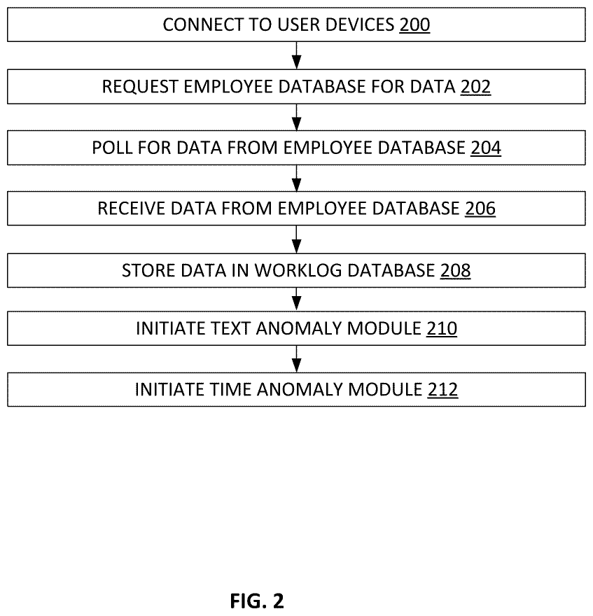

FIG. 2 is a flowchart illustrating an exemplary method for detecting worklog anomalies, which may be performed based on execution of the anomaly detection module 108. The process begins with the anomaly detection module 108 connecting, at step 200, to the user devices 1-N 122. For example, the anomaly detection module 108 may connect to the user devices 122 through the communication network interface 104, which may be a wired and/or wireless network. The communication network interface 104, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network interface 104 may allow ubiquitous access to shared pools of configurable system resources and higher-level services that can be rapidly provisioned with minimal management effort, often over the Internet, and relies on sharing of resources to achieve coherence and economies of scale, like a public utility, while third-party clouds enable organizations to focus on their core businesses instead of expending resources on computer infrastructure and maintenance.

The anomaly detection module 108 sends, at step 202, a request to the user devices 1-N 122 input module 124 for the data stored in the employee database 126. For example, the anomaly detection module 108 sends a request for the data stored in the employee database 126, which may contain the inputs collected from a user through the process described in the input module 124. For example, the database may include the employee ID, which may be a unique identifier for each employee, enabling the system to group the work tasks by employee and track their individual contributions over time. The database may contain the task which describes the nature of the work task completed by the employee. Examples of tasks may be designing a new website, coding a new feature, conducting market research, responding to customer inquiries, team meetings, meetings with other employees, anomalies in the work log, etc. which provides context for the work being performed and allows the time tracking network server 102 to analyze how time is being spent across different types of tasks. The database may include the time spent, displayed in hours, which indicates the amount of time that the employee spent on each task which provides a quantitative measure of productivity and can be used to track progress, estimate project timelines, and allocate resources effectively. In some embodiments, the database may include the date, time, a project or task code, notes from the employee, the priority level of the task for the individual employee, the status of the task or project the task is for, comments or feedback from the employee, if the task was approved or reviewed, etc.

The anomaly detection module 108 continuously polls at step 204 to receive the data stored in the employee database 126 from the input module 124. For example, the anomaly detection module 108 checks the status of the user device 122 by periodically sending requests or signals rather than waiting for it to send notifications or interrupt signals, such as checking to determine if the data stored in the employee database 126 is ready.

The anomaly detection module 108 receives, at step 206, the data stored in the employee database 126 from the input module 124. For example, the anomaly detection module 108 receives the data stored in the employee database 126, which may contain the inputs collected from a user through the process described in the input module 124. For example, the database may include the employee ID, which may be a unique identifier for each employee, enabling the system to group the work tasks by employee and track their individual contributions over time. The database may contain the task which describes the nature of the work task completed by the employee. Examples of tasks may be designing a new website, coding a new feature, conducting market research, responding to customer inquiries, team meetings, meetings with other employees, anomalies in the work log, etc. which provides context for the work being performed and allows the time tracking network server 102 to analyze how time is being spent across different types of tasks. The database may include the time spent, displayed in hours, which indicates the amount of time the employee spent on each task which provides a quantitative measure of productivity and can be used to track progress, estimate project timelines, and allocate resources effectively. In some embodiments, the database may include the date, time, a project or task code, notes from the employee, the priority level of the task for the individual employee, the status of the task or project the task is for, comments or feedback from the employee, if the task was approved or reviewed, etc.

The anomaly detection module 108 stores, at step 208, the received data in the work log database 114. For example, the anomaly detection module 108 stores the received data in the work log database 114. For example, the database may include the employee ID, which may be a unique identifier for each employee, enabling the system to group the work tasks by employee and track their individual contributions over time. The database may contain the task which describes the nature of the work task completed by the employee. Examples of tasks may be designing a new website, coding a new feature, conducting market research, responding to customer inquiries, team meetings, meetings with other employees, anomalies in the work log, etc. which provides context for the work being performed and allows the time tracking network server 102 to analyze how time is being spent across different types of tasks. The database may include the time spent, displayed in hours, which indicates the amount of time that the employee spent on each task which provides a quantitative measure of productivity and can be used to track progress, estimate project timelines, and allocate resources effectively. In some embodiments, the database may include the date, time, a project or task code, notes from the employee, the priority level of the task for the individual employee, the status of the task or project the task is for, comments or feedback from the employee, if the task was approved or reviewed, etc.

The anomaly detection module 108 initiates, at step 210, the text anomaly module 110. For example, the text anomaly module 110 begins by being initiated by the anomaly detection module 108. The text anomaly module 110 extracts the data stored in the training database 116. The text anomaly module 110 generates the text model. The text anomaly module 110 filters the work log database 114 on the first employee. The text anomaly module 110 extracts the data from the work log database 114 of the filtered employee. The text anomaly module 110 performs the text model on the extracted data to determine if there are any anomalies with the employee's work log tasks. The text anomaly module 110 determines if there is an anomaly in the employee's work log text data. If it is determined that there is an anomaly contained in the employee's work log text data, the text anomaly module 110 stores the anomaly data in the anomaly database 118. If it is determined that there are no anomalies contained in the employee's work log text data, or after the anomalies have been stored in the anomaly database 118, the text anomaly module 110 determines if more employees are remaining in the work log database 114. If it is determined that there are more employees stored in the work log database 114, the text anomaly module 110 filters the work log database 114 on the next employee, and the process returns to extracting the data from the work log database 114. If it is determined that there are no more employees stored in the work log database 114, the text anomaly module 110 returns to the anomaly detection module 108.

The anomaly detection module 108 initiates, at step 212, the time anomaly module 112. For example, the time anomaly module 112 begins by being initiated by the anomaly detection module 108. The time anomaly module 112 extracts the data stored in the training database 116. The time anomaly module 112 filters the work log database 114 on the first employee. The time anomaly module 112 extracts the data from the work log database 114 of the filtered employee. The time anomaly module 112 performs the time model on the extracted data to determine if there are any anomalies with the employee's work log time allocations. The time anomaly module 112 determines if there is an anomaly in the employee's work log time data. If it is determined that there is an anomaly contained in the employee's work log time data, the time anomaly module 112 stores the anomaly data in the anomaly database 118. If it is determined that there are no anomalies contained in the employee's work log time data or after the anomalies have been stored in the anomaly database 118, the time anomaly module 112 determines if more employees are remaining in the work log database 114. If it is determined that there are more employees stored in the work log database 114, the time anomaly module 112 filters the work log database 114 on the next employee, and the process returns to extracting the data from the work log database 114. If it is determined that there are no more employees stored in the work log database 114, the time anomaly module 112 returns to the anomaly detection module 108.

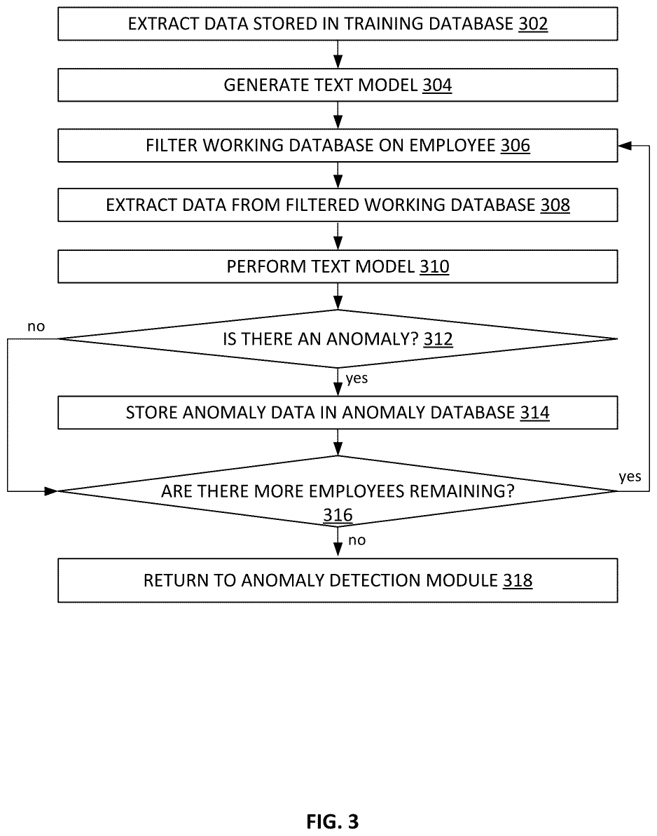

FIG. 3 is a flowchart illustrating an exemplary method for detecting text-based anomalies, which may be performed based on execution of the text anomaly module 110. Execution of the text anomaly module 110 may have been initiated by the anomaly detection module 108, and such initiation may occur periodically (e.g., daily, weekly, monthly, quarterly, yearly, etc.) to detect text anomalies in the work log database 114. In some embodiments, the text anomaly module 110 may be initiated by querying the work log database 114 for a new data entry, and if there is a new data entry, extract the data and perform the text model to determine if there is a text anomaly within the work log data entry.

The text anomaly module 110 extracts, at step 302, the data stored in the training database 116. For example, the text anomaly module 110 extracts the training data to generate the text model. The training database 116 may contain non-anomalous work log data to generate the models. The training database 116 may contain a plurality of employee IDs, work log tasks, and time allocated to the tasks. In some embodiments, the database may include the date, time, a project or task code, notes from the employee, the priority level of the task for the individual employee, the status of the task or project the task is for, comments or feedback from the employee, if the task was approved or reviewed, etc. In some embodiments, the training database 116 may collect data from the text anomaly module 110 and time anomaly module 112 that has been deemed non-anomalous and can further be used to train future models. In some embodiments, the training data may be a set of input data used to teach a machine learning model, such as the text model or time model, to make predictions or classifications based on that data. For example, the training data may consist of two components, input data, and target data. The input data may be the data that the model will use to make predictions or classifications. The input data can be any type of data that the model is designed to work with, such as images, text, audio, or numerical data. The target data may be the correct output or label associated with each input data point. The target data may be used to train the model to make accurate predictions or classifications based on the input data. In some embodiments, the models may iteratively adjust their parameters to minimize the difference between their predicted outputs and the target outputs in the training data.

The text anomaly module 110 generates, at step 304, the text model. For example, the text anomaly module 110 may generate the text model by computing the embedding of the training text and then computing the statistics, such as the mean, covariance matrix, inverse covariance matrix, etc., of the embeddings. For example, the text anomaly module 110 may compute the embedding of the training data, which may represent words or sentences as vectors of numerical values that can be used as inputs to machine learning models. The words may be represented as high-dimensional vectors that capture the meanings and context of the words. The text anomaly module 110 may use natural language processing techniques, such as Sentence-BERT for creating sentence embeddings. For example, Sentence-BERT is a framework for creating sentence embeddings using a pre-trained transformer-based neural network. It fine-tunes the pre-trained model on a sentence similarity task in which the resulting sentence embeddings are optimized to capture the semantic similarity between sentences. For example, similarity-based contrastive sentence embedding may be a method for learning sentence embeddings by contrasting positive and negative examples and using a neural network architecture to generate embeddings for pairs of similar and dissimilar sentences and then optimizes the network to maximize the similarity between embeddings of similar sentences and minimize the similarity between embeddings of dissimilar sentences. Then the text anomaly module 110 computes the statistics, such as the mean, covariance matrix, inverse covariance matrix, etc., from the embeddings of the training data that will be the model to determine if the work log embeddings are anomalous or not. For example, the mean of the embeddings may be the average of the individual word or sentence embeddings. The mean of the embeddings allows the text anomaly module 110 to generate a single vector representation of the sentence that captures its overall meaning and can be used when the text model is performed by comparing the mean of the training data embeddings to the embeddings from the work log database 114. For example, the covariance matrix of the embeddings may be a matrix describing the statistical relationship between pairs of word or sentence embeddings, such as the variance and covariance of each pair of embeddings. For example, the diagonal elements of the matrix represent the variance of each embedding, while the off-diagonal elements represent the covariance between pairs of embeddings. The covariance matrix can be used to analyze the relationship between words or sentences and provide insights into the structure and organization of the underlying language. In some embodiments, the text model may be an unsupervised model that uses unsupervised learning techniques, such as clustering or outlier detection, to identify the text's deviation patterns. For example, k-means clustering or Gaussian mixture models may be used to identify groups of similar text passages, and anomalies can be identified as passages that do not fit within any of the clusters. In some embodiments, the text model may be a rule-based model which uses handcrafted rules or heuristics to identify anomalies in the text. For example, a rule-based model might flag any sentence containing words or phrases that are not commonly used in the corpus or violate certain syntactic or semantic rules of the language. In some embodiments, the text model may be a machine learning model which may be trained on a labeled dataset of anomalous and normal text to identify patterns of deviation in the text. For example, support vector machines (SVMs), decision trees, or neural networks can be used to classify text passages as anomalous or normal based on features such as word frequency, sentence length, or syntactic structure. In some embodiments, the text model may be a deep learning model, such as autoencoders or variational autoencoders, which may be used to learn a compressed representation of the text and identify deviations from the normal distribution of the learned embeddings. For example, a variational autoencoder can be trained to generate new sentences based on the learned embeddings, and anomalies can be identified as sentences with a low probability of being generated from the learned distribution.

The text anomaly module 110 filters, at step 306, the work log database 114 on the first employee. For example, the text anomaly module 110 filters the work log database 114 on the first employee to determine if there are any anomalies with the employee's work log data. In some embodiments, the text anomaly module 110 may perform the text model on the entire work log database 114 and extract the employee ID if an anomaly is detected.

The text anomaly module 110 extracts, at step 308, the data from the work log database 114 of the filtered employee. For example, the data extracted may be the employee ID, which may be a unique identifier for each employee, enabling the system to group the work tasks by employee and track their individual contributions over time. The data extracted may be the task that describes the nature of the work task completed by the employee. Examples of tasks may be designing a new website, coding a new feature, conducting market research, responding to customer inquiries, team meetings, meetings with other employees, anomalies in the work log, etc. which provides context for the work being performed and allows the time tracking network server 102 to analyze how time is being spent across different types of tasks. In some embodiments, the data extracted may include the date, time, a project or task code, notes from the employee, the priority level of the task for the individual employee, the status of the task or project the task is for, comments or feedback from the employee, if the task was approved or reviewed, etc.

The text anomaly module 110 performs, at step 310, the text model on the extracted data to determine if there are any anomalies with the employee's work log tasks. For example, the text anomaly module 110 may have been trained to determine the embedding for the extracted data and then computes the Mahalanobis distance using the statistics computed from the training data. If the distance between the two is above a predetermined threshold, the text anomaly module 110 can determine if the text is an anomaly or not. For example, the text anomaly module 110 may compute the embedding of the extracted data, which may represent words or sentences as vectors of numerical values that can be used as inputs to machine learning models. The words may be represented as high-dimensional vectors that capture the meanings and context of the words. The text anomaly module 110 may use natural language processing techniques, such as Sentence-BERT for creating sentence embeddings. For example, Sentence-BERT is a framework for creating sentence embeddings using a pre-trained transformer-based neural network. It fine-tunes the pre-trained model on a sentence similarity task in which the resulting sentence embeddings are optimized to capture the semantic similarity between sentences. For example, similarity-based contrastive sentence embedding may be a method for learning sentence embeddings by contrasting positive and negative examples and using a neural network architecture to generate embeddings for pairs of similar and dissimilar sentences and then optimizes the network to maximize the similarity between embeddings of similar sentences and minimize the similarity between embeddings of dissimilar sentences. Then the text anomaly module 110 computes the Mahalanobis distance between the embeddings from the extracted data from the work log database 114 and the statistics computed from the training data, such as the mean, covariance matrix, inverse covariance matrix, etc., to determine if the distance exceeds a predetermined threshold. For example, the Mahalanobis distance considers the correlation between variables in the dataset. It scales each variable based on its variance, which is calculated by taking the square root of the sum of squared standardized deviations, where each standardized deviation is divided by the corresponding standard deviation of the variable. For example, the threshold may be set to flag embeddings that are significantly different from the training data (normal) distribution. For example, the Mahalanobis distance may be used to compare the similarity of embeddings of text data if each sentence or phrase is represented as a vector of embeddings. The Mahalanobis distance can be calculated between pairs of sentences or phrases to determine their similarity. In some embodiments, the text model may be an unsupervised model that uses unsupervised learning techniques, such as clustering or outlier detection, to identify the text's deviation patterns. For example, k-means clustering or Gaussian mixture models may be used to identify groups of similar text passages, and anomalies can be identified as passages that do not fit within any of the clusters. In some embodiments, the text model may be a rule-based model which uses handcrafted rules or heuristics to identify anomalies in the text. For example, a rule-based model might flag any sentence containing words or phrases that are not commonly used in the corpus or violate certain syntactic or semantic rules of the language. In some embodiments, the text model may be a machine learning model which may be trained on a labeled dataset of anomalous and normal text to identify patterns of deviation in the text. For example, support vector machines (SVMs), decision trees, or neural networks can be used to classify text passages as anomalous or normal based on features such as word frequency, sentence length, or syntactic structure. In some embodiments, the text model may be a deep learning model, such as autoencoders or variational autoencoders, which may be used to learn a compressed representation of the text and identify deviations from the normal distribution of the learned embeddings. For example, a variational autoencoder can be trained to generate new sentences based on the learned embeddings, and anomalies can be identified as sentences that have a low probability of being generated from the learned distribution.

The text anomaly module 110 determines, at step 312, if there is an anomaly in the employee's work log text data. For example, the text anomaly module 110 determines if there is an anomaly by identifying employees' work log tasks that are significantly different from the normal distribution of the training data. For example, the text anomaly module 110 calculates the Mahalanobis distance between each sentence embedding, the task the employee inputted in the work log, and the mean embedding of the training dataset and then compute the distribution of Mahalanobis distances and set a threshold based on a chosen level of significance, for example, a p-value of 0.05. For example, the text anomaly module 110 uses the mean and standard deviation of the distribution to determine the threshold. For example, if the mean Mahalanobis distance is 5 and the standard deviation is 2, the selected threshold may be 9 to flag embeddings that are more than two standard deviations from the mean. Any embedding from extracted work log data with a Mahalanobis distance greater than 9 would be considered significantly different from the normal distribution and thus be considered anomalous and then be stored in the anomaly database 118 to be reviewed.

If it is determined that there is an anomaly contained in the employee's work log text data, the text anomaly module 110 stores, at step 314, the anomaly data in the anomaly database 118. For example, if the extracted data from the work log database 114 is determined to be anomalous, the text anomaly module 110 stores the anomalous data entry in the anomaly database 118, such as the employee ID, the anomalous task, and the time allocated to the anomalous task. The database may be used by users of the time tracking network server 102 to review, approve, and track projects or the productivity of employees, etc. In some embodiments, the users of the time tracking network server 102 may display the anomaly database 118 on the user interface 106 to review employee performance, make informed business decisions, adjust processes or timelines, etc. For example, if an employee is producing the same amount of work in half the time as all the other employees, the user of the time tracking network server 102 may interview or discuss that employee's process to determine if their methodology should be adopted business wide. Another example may be if an employee is performing poorly or not up to the same standard as other employees. The user of the time tracking network server 102 may recommend additional training for the employee.

If it is determined that there are no anomalies contained in the employee's work, log text data or after the anomalies have been stored in the anomaly database 118, the text anomaly module 110 determines, at step 316, if more employees are remaining in the work log database 114. For example, the text anomaly module 110 continuously loops through the process until it is determined that the text model has processed every employee ID and the associated work log data. If it is determined that more employees are stored in the work log database 114, the text anomaly module 110 may return to step 306 to filter the work log database 114 on the next employee, and the process returns to extracting the data from the work log database 114. If it is determined that there are no more employees stored in the work log database 114, the text anomaly module 110 returns, at step 318, to the anomaly detection module 108.

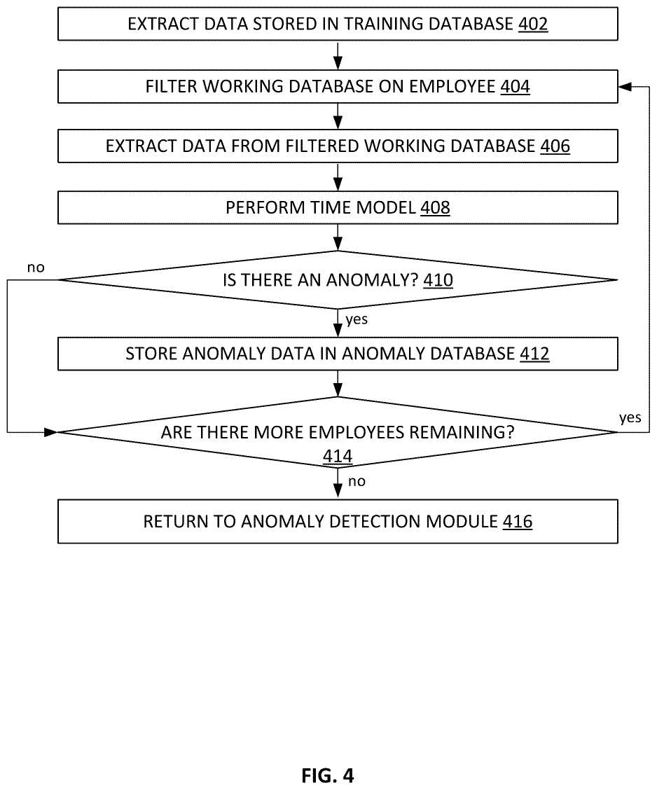

FIG. 4 is a flowchart illustrating an exemplary method for detecting time-based anomalies, which may be performed based on execution of the time anomaly module 112. The time anomaly module 112 may be initiated by the anomaly detection module 108, which may occur periodically (e.g., daily, weekly, monthly, quarterly, yearly, etc.) to detect time anomalies in the work log database 114. In some embodiments, the time anomaly module 112 may be initiated by querying the work log database 114 for a new data entry, and if there is a new data entry, extract the data and perform the time model to determine if there is a time anomaly within the work log data entry.

The time anomaly module 112 extracts, at step 402, the data stored in the training database 116. For example, the time anomaly module 112 extracts the training data to generate the time model. The training database 116 may contain non-anomalous work log data to generate the models. The training database 116 may contain a plurality of employee IDs, work log tasks, and time allocated to the tasks. In some embodiments, the database may include the date, time, a project or task code, notes from the employee, the priority level of the task for the individual employee, the status of the task or project the task is for, comments or feedback from the employee, if the task was approved or reviewed, etc. In some embodiments, the training database 116 may collect data from the text anomaly module 110 and time anomaly module 112 that has been deemed non-anomalous and can further be used to train future models. In some embodiments, the training data may be a set of input data used to teach a machine learning model, such as the text model or time model, to make predictions or classifications based on that data. For example, the training data may consist of two components, input data, and target data. The input data may be the data that the model will use to make predictions or classifications. The input data can be any type of data that the model is designed to work with, such as images, text, audio, or numerical data. The target data may be the correct output or label associated with each input data point. The target data may be used to train the model to make accurate predictions or classifications based on the input data. In some embodiments, the models may iteratively adjust their parameters to minimize the difference between their predicted and target outputs in the training data.

The time anomaly module 112 filters, at step 404, the work log database 114 on the first employee. For example, the time anomaly module 112 filters the work log database 114 on the first employee to determine if there are any anomalies with the employee's work log time data. In some embodiments, the time anomaly module 112 may perform the time model on the entire work log database 114 and extract the employee ID if an anomaly is detected.

The time anomaly module 112 extracts, at step 406, the data from the work log database 114 of the filtered employee. For example, the data extracted may be the employee ID, which may be a unique identifier for each employee, enabling the system to group the work tasks by employee and track their individual contributions over time. The data extracted may be the time spent, displayed in hours, which indicates the amount of time that the employee spent on each task which provides a quantitative measure of productivity and can be used to track progress, estimate project timelines, and allocate resources effectively. The data extracted may also be the task that describes the nature of the work task completed by the employee. Examples of tasks may be designing a new website, coding a new feature, conducting market research, responding to customer inquiries, team meetings, meetings with other employees, anomalies in the work log, etc. which provides context for the work being performed and allows the time tracking network server 102 to analyze how time is being spent across different types of tasks. In some embodiments, the data extracted may include the date, time, a project or task code, notes from the employee, the priority level of the task for the individual employee, the status of the task or project the task is for, comments or feedback from the employee, if the task was approved or reviewed, etc.

The time anomaly module 112 performs, at step 408, the time model on the extracted data to determine if there are any anomalies with the employee's work log time allocations. The time anomaly module 112 determines, at step 410, if there is an anomaly in the employee's work log time data. For example, the time anomaly module 112 may compute the text embedding of the extracted data from the work log database 114, compute the similarity score to find the related work logs, and then use the similarity and count as a weightage parameter to compute the weighted statistics of time information. For example, the time anomaly module 112 computes the embedding for the extracted data from the work log database 114 and finds the top-k similar records from the extracted training data based on the similarity score threshold. For example, the time anomaly module 112 may compute the embedding of the extracted data, which may represent words or sentences as vectors of numerical values that can be used as inputs to machine learning models.

The words may be represented as high-dimensional vectors that capture the meanings and context of the words. The time anomaly module 112 may use natural language processing techniques, such as Sentence-BERT for creating sentence embeddings. For example, Sentence-BERT is a framework for creating sentence embeddings using a pre-trained transformer-based neural network. It fine-tunes the pre-trained model on a sentence similarity task in which the resulting sentence embeddings are optimized to capture the semantic similarity between sentences. For example, similarity-based contrastive sentence embedding may be a method for learning sentence embeddings by contrasting positive and negative examples and using a neural network architecture to generate embeddings for pairs of similar and dissimilar sentences and then optimizes the network to maximize the similarity between embeddings of similar sentences and minimize the similarity between embeddings of dissimilar sentences. For example, the time anomaly module 112 may compute a similarity score, a numerical value indicating the degree of similarity between two pieces of text, such as two sentences or two documents.

In some embodiments, the score may be a value between 0 and 1, with 1 indicating perfect similarity and 0 indicating no similarity. Then the time anomaly module 112 may perform a top-k method in which the most similar data entries are selected from the data set based on their similarity score, for example, the highest similarity scores. Then the time anomaly module 112 computes the weighted statistics, such as mean, weighted variances, weighted count, etc., using the top-k similar training data entries and the extracted data from the work log database 114. For example, the time anomaly module 112 may compute the weighted statistics, such as mean, variance, and count. For example, weighted statistics may be a statistical measure that takes into account the relative importance or frequency of each data point by assigning weights to each, which may be used to adjust the contribution of each data point to the final result based on their importance or frequency. For example, the weighted mean may be a measure of the central tendency of a dataset, where each observation is multiplied by a weight that reflects its relative importance or frequency and may be calculated by summing the products of each observation and its weight and dividing by the sum of the weights. For example, the weighted variance may be a measure of the variability or spread of a dataset, where each observation is multiplied by a weight that reflects its relative importance or frequency and may be calculated by summing the products of each observation's deviation from the weighted mean, squared, and multiplied by its weight, and dividing by the sum of the weights. For example, the weighted count may be a measure of the number of observations in a dataset, where each observation is multiplied by a weight that reflects its relative importance or frequency and may be calculated by summing the weights of each observation.

The time anomaly module 112 computes the probability and z-score using the weighted statistics to detect an anomaly of the time based on a threshold which is set in the validation set. For example, the computed probability may be a measure of the likelihood or chance of an event occurring and may be a number between 0 and 1, where 0 indicates that the event is impossible, and 1 indicates that the event is certain. For example, the computed z-score may be a statistical measure that indicates how many standard deviations a data point is from the mean of a distribution. It may be calculated by subtracting the mean of the distribution from the data point and then dividing it by the standard deviation of the distribution. A positive z-score indicates that the data point is above the mean, while a negative z-score indicates that the data point is below the mean. The threshold to determine if a data entry is anomalous or not may be set during the validation set, which is a subset of a training dataset that is used to evaluate the performance of a machine learning model during the training process. The model is evaluated on the validation set after each iteration, and the hyperparameters are adjusted to optimize the model's performance on the validation set. For example, the threshold may be a decision threshold set to determine the predicted class based on the model's output probability. For example, if the model outputs a probability of 0.7 for the positive class, such as anomalous, and the decision threshold is set to 0.5, the predicted class will be anomalous.

The predicted class will not be anomalous if the output probability is less than 0.5. In some embodiments, in the event of a unique data point, the time anomaly module 112 may compute the top-k records from the training data based on the similarity score threshold and then, using the top-k records, compute the weighted statistics and then store the weighted statistics for every unique data entry. Then for inference, the time anomaly module 112 computes the embedding for the extracted data entry, finds the top-k records from the training data, and uses the previously weighted statistics to compute the probability and z-score and detect anomalies based on the threshold determined. Then the time anomaly module 112 sets a percentage threshold on those k-records and determines if the extracted data entry was anomalous.

If it is determined that there is an anomaly contained in the employee's work log time data, the time anomaly module 112 stores, at step 412, the anomaly data in the anomaly database 118. For example, if the extracted data from the work log database 114 is determined to be anomalous, the time anomaly module 112 stores the anomalous data entry in the anomaly database 118, such as the employee ID, task, and time allocated to the task. The database may be used by users of the time tracking network server 102 to review, approve, and track projects or the productivity of employees, etc. In some embodiments, the users of the time tracking network server 102 may display the anomaly database 118 on the user interface 106 to review employee performance, make informed business decisions, adjust processes or timelines, etc. For example, if an employee is producing the same amount of work in half the time as all the other employees, the user of the time tracking network server 102 may interview or discuss that employee's process to determine if their methodology should be adopted business wide. Another example may be if an employee is performing poorly or not up to the same standard as other employees. The user of the time tracking network server 102 may recommend additional training for the employee.

If it is determined that there are no anomalies contained in the employee's work log time data or after the anomalies have been stored in the anomaly database 118, the time anomaly module 112 determines, at step 414, if more employees are remaining in the work log database 114. For example, the time anomaly module 112 continuously loops through the process until it is determined that the time model has processed every employee ID and the associated work log data. If it is determined that there are more employees stored in the work log database 114, the time anomaly module 112 returns to step 404 to filter the work log database 114 on the next employee, and the process returns to extracting the data from the work log database 114. If it is determined that there are no more employees stored in the work log database 114, the time anomaly module 112 returns, at step 416, to the anomaly detection module 108.

An exemplary work log database 114 is provided below:

| Employee ID | Task | Time Spent (in hours) |
|---|---|---|
| 001 | Design new website | 4.5 |
| 001 | Write blog post | 2 |
| 002 | Code new feature | 7.25 |
| 003 | Conduct market research | 3.75 |
| 002 | Test new software | 1.5 |
| 001 | Attend team meeting | 1 |
| 003 | Respond to customer inquiries | 2.25 |
| 002 | Debug software issues | 3 |
| — | — | — |
| — | — | — |
| — | — | — |

The database contains the work logs collected from user device 1-N 122 through the process described in the anomaly detection module 108. For example, the database may include the employee ID, which may be a unique identifier for each employee, enabling the system to group the work tasks by employee and track their individual contributions over time. The database may contain the task which describes the nature of the work task completed by the employee. Examples of tasks may be designing a new website, coding a new feature, conducting market research, responding to customer inquiries, team meetings, meetings with other employees, anomalies in the work log, etc. which provides context for the work being performed and allows the time tracking network server 102 to analyze how time is being spent across different types of tasks. The database may include the time spent, displayed in hours, which indicates the amount of time that the employee spent on each task which provides a quantitative measure of productivity and can be used to track progress, estimate project timelines, and allocate resources effectively. In some embodiments, the database may include the date, time, a project or task code, notes from the employee, the priority level of the task for the individual employee, the status of the task or project the task is for, comments or feedback from the employee, if the task was approved or reviewed, etc.

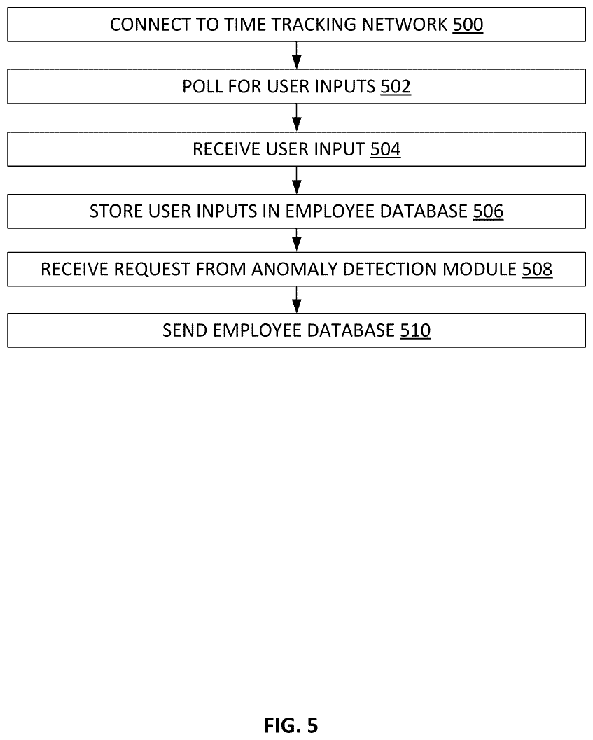

FIG. 5 is a flowchart illustrating an exemplary method of input collection for anomaly detection, which may be performed based on execution of the input module 124. The input module 124 may connect, at step 600, to the time tracking network server 102. For example, the input module 124 may connect to the time tracking network server 102 through the cloud 120. In some embodiments, the input module 124 may connect to the time tracking network server 102 through a website connection, application connection, API connection, etc., to send the employee's work log data from the user device 122 to the time tracking network server 102.

The input module 124 continuously polls, at step 502, for the user inputs. For example, the input module 124 is continuously polling to receive the user inputs, such as the user's work log data which may include the employee ID, which may be a unique identifier for each employee, enabling the system to group the work tasks by employee and track their individual contributions over time.

The input module 124 receives the user inputs, at step 504, through the user device 1-N 122. For example, the input module 124 receives the user inputs, such as the employee ID, which may be a unique identifier for each employee, enabling the system to group the work tasks by employee and track their individual contributions over time. In some embodiments, the inputs may include the date, time, a project or task code, notes from the employee, the priority level of the task for the individual employee, the status of the task or project the task is for, comments or feedback from the employee, if the task was approved or reviewed, etc.

The input module 124 stores, at step 506, the user inputs in the employee database 126. For example, the input module 124 stores the user inputs in the employee database 126 which may contain the employee ID, which may be a unique identifier for each employee, enabling the system to group the work tasks by employee and track their individual contributions over time. The database may contain the task which describes the nature of the work task completed by the employee. Examples of tasks may be designing a new website, coding a new feature, conducting market research, responding to customer inquiries, team meetings, meetings with other employees, anomalies in the work log, etc. which provides context for the work being performed and allows the time tracking network server 102 to analyze how time is being spent across different types of tasks. The database may include the time spent, displayed in hours, which indicates the amount of time that the employee spent on each task which provides a quantitative measure of productivity and can be used to track progress, estimate project timelines, and allocate resources effectively. In some embodiments, the database may include the date, time, a project or task code, notes from the employee, the priority level of the task for the individual employee, the status of the task or project the task is for, comments or feedback from the employee, if the task was approved or reviewed, etc.

The input module 124 receives, at step 508, a request from the anomaly detection module 108 for the data stored in the employee database 126. For example, the input module 124 receives a request from the anomaly detection module 108 for the data stored in the employee database 126, which may occur periodically, such as every day, week, month, quarter, year, etc.

The input module 124 sends, at step 510, the data stored in the employee database 126 to the anomaly detection module 108 and returns to continuously polling for the user inputs. For example, the input module 124 sends the user inputs, such as the employee ID, which may be a unique identifier for each employee, enabling the system to group the work tasks by employee and track their individual contributions over time, etc. to the anomaly detection module 108 and the process returns to the continuously polling for the user inputs.

An exemplary employee database 126 is provided below:

| Employee ID | Task | Time Spent (in hours) |
|---|---|---|
| 001 | Design new website | 4.5 |
| 001 | Write blog post | 2 |
| 001 | Attend team meeting | 1 |
| — | — | — |
| — | — | — |
| — | — | — |

The database contains the inputs collected from a user through the process described in the input module 124 and is sent to the anomaly detection module 108 to be stored in the work log database 114. For example, the database may include the employee ID, which may be a unique identifier for each employee, enabling the system to group the work tasks by employee and track their individual contributions over time. The database may contain the task which describes the nature of the work task completed by the employee. Examples of tasks may be designing a new website, coding a new feature, conducting market research, responding to customer inquiries, team meetings, meetings with other employees, anomalies in the work log, etc. which provides context for the work being performed and allows the time tracking network server 102 to analyze how time is being spent across different types of tasks. The database may include the time spent, displayed in hours, which indicates the amount of time that the employee spent on each task which provides a quantitative measure of productivity and can be used to track progress, estimate project timelines, and allocate resources effectively. In some embodiments, the database may include the date, time, a project or task code, notes from the employee, the priority level of the task for the individual employee, the status of the task or project the task is for, comments or feedback from the employee, if the task was approved or reviewed, etc.

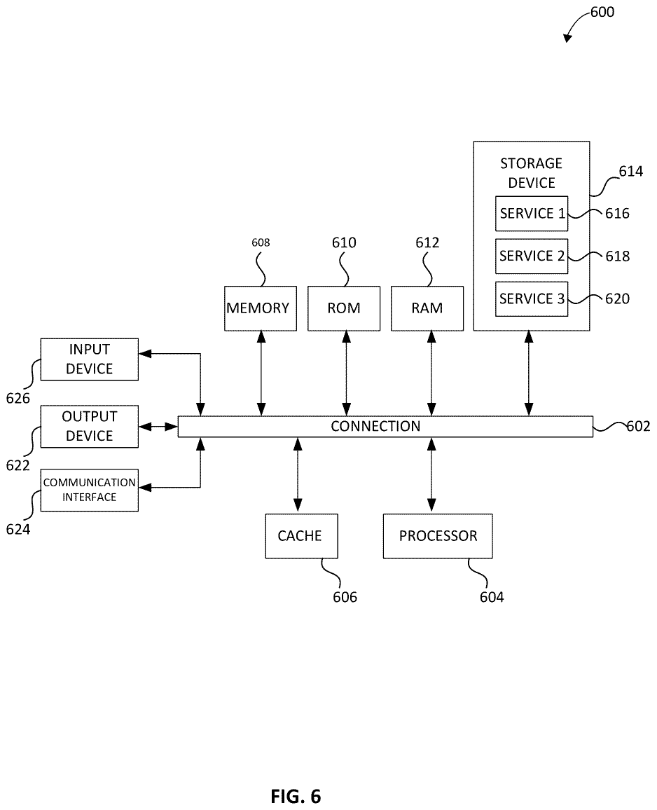

FIG. 6 shows an example of computing system 600, which can be for example any computing device making up education network 102, or any component thereof in which the components of the system are in communication with each other using connection 602. Connection 602 can be a physical connection via a bus, or a direct connection into processor 604, such as in a chipset architecture. Connection 602 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 600 includes at least one processing unit (CPU or processor) 604 and connection 602 that couples various system components including system memory 608, such as read-only memory (ROM) 610 and random access memory (RAM) 612 to processor 604. Computing system 600 can include a cache of high-speed memory 608 connected directly with, in close proximity to, or integrated as part of processor 604.

Processor 604 can include any general purpose processor and a hardware service or software service, such as services 606, 618, and 620 stored in storage device 614, configured to control processor 604 as well as a special-purpose processor where software instructions are incorporated into the actual processor design. Processor 604 may essentially be a completely self-contained computing system, containing multiple cores or processors, a bus, memory controller, cache, etc. A multi-core processor may be symmetric or asymmetric.

To enable user interaction, computing system 600 includes an input device 626, which can represent any number of input mechanisms, such as a microphone for speech, a touch-sensitive screen for gesture or graphical input, keyboard, mouse, motion input, speech, etc. Computing system 600 can also include output device 622, which can be one or more of a number of output mechanisms known to those of skill in the art. In some instances, multimodal systems can enable a user to provide multiple types of input/output to communicate with computing system 600. Computing system 600 can include communication interface 624, which can generally govern and manage the user input and system output. There is no restriction on operating on any particular hardware arrangement, and therefore the basic features here may easily be substituted for improved hardware or firmware arrangements as they are developed.

Storage device 614 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 614 can include software services, servers, services, etc., that when the code that defines such software is executed by the processor 604, it causes the system to perform a function. In some embodiments, a hardware service that may deploy a particular function can include the software component stored in a computer-readable medium in connection with the hardware components, such as processor 604, connection 602, output device 622, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

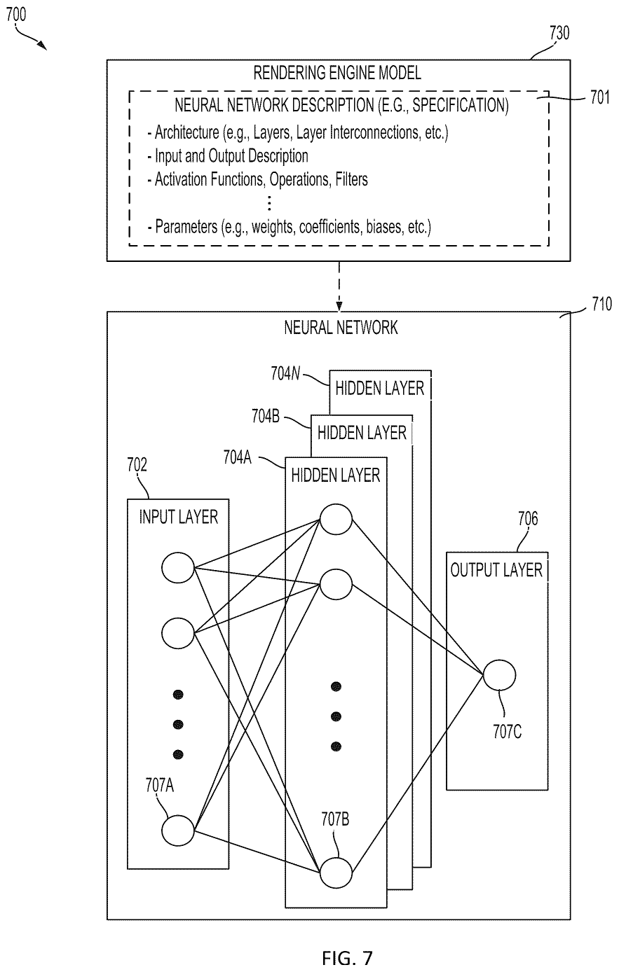

FIG. 7 illustrates an example neural network architecture. Architecture 700 includes a neural network 710 defined by an example neural network description 701 in rendering engine model (neural controller) 730. The neural network 710 can represent a neural network implementation of a rendering engine for rendering media data. The neural network description 701 can include a full specification of the neural network 710, including the neural network architecture 700. For example, the neural network description 701 can include a description or specification of the architecture 700 of the neural network 710 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 710 reflects the architecture 700 defined in the neural network description 701. In this example, the neural network 710 includes an input layer 702, which includes input data, such as extracted coursework progression data. In one illustrative example, the input layer 702 can include data representing a portion of the input media data such as a patch of data or pixels (e.g., extracted coursework progression data).

The neural network 710 includes hidden layers 704A through 704 N (collectively “804” hereinafter). The hidden layers 704 can include n number of hidden layers, where n is an integer greater than or equal to one. The number of hidden layers can include as many layers as needed for a desired processing outcome and/or rendering intent. The neural network 710 further includes an output layer 706 that provides an output (e.g., predicted status) resulting from the processing performed by the hidden layers 704. In one illustrative example, the output layer 706 can predict statuses.

The neural network 710 in this example is a multi-layer neural network of interconnected nodes. Each node can represent a piece of information. Information associated with the nodes is shared among the different layers and each layer retains information as information is processed. In some cases, the neural network 710 can include a feed-forward neural network, in which case there are no feedback connections where outputs of the neural network are fed back into itself. In other cases, the neural network 710 can include a recurrent neural network, which can have loops that allow information to be carried across nodes while reading in input.

Information can be exchanged between nodes through node-to-node interconnections between the various layers. Nodes of the input layer 702 can activate a set of nodes in the first hidden layer 704A. For example, as shown, each of the input nodes of the input layer 702 is connected to each of the nodes of the first hidden layer 704A. The nodes of the hidden layer 704A can transform the information of each input node by applying activation functions to the information. The information derived from the transformation can then be passed to and can activate the nodes of the next hidden layer (e.g., 704B), which can perform their own designated functions. Example functions include convolutional, up-sampling, data transformation, pooling, and/or any other suitable functions. The output of the hidden layer (e.g., 704B) can then activate nodes of the next hidden layer (e.g., 704 N), and so on. The output of the last hidden layer can activate one or more nodes of the output layer 706, at which point an output is provided. In some cases, while nodes (e.g., nodes 708A, 708B, 708C) in the neural network 710 are shown as having multiple output lines, a node has a single output and all lines shown as being output from a node represent the same output value.

In some cases, each node or interconnection between nodes can have a weight that is a set of parameters derived from training the neural network 710. For example, an interconnection between nodes can represent a piece of information learned about the interconnected nodes. The interconnection can have a numeric weight that can be tuned (e.g., based on a training dataset), allowing the neural network 710 to be adaptive to inputs and able to learn as more data is processed.

The neural network 710 can be pre-trained to process the features from the data in the input layer 702 using the different hidden layers 704 in order to provide the output through the output layer 706. In an example in which the neural network 710 is used to predict statuses, the neural network 710 can be trained using training data that includes historical coursework progression data and historical statuses. For instance, extracted coursework progression data can be input into the neural network 710, which can be processed by the neural network 710 to generate outputs which can be used to tune one or more aspects of the neural network 710, such as weights, biases, etc.

In some cases, the neural network 710 can adjust weights of nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training media data until the weights of the layers are accurately tuned.

For a first training iteration for the neural network 710, the output can include values that do not give preference to any particular class due to the weights being randomly selected at initialization. For example, if the output is a vector with probabilities that the object includes different product(s) and/or different users, the probability value for each of the different product and/or user may be equal or at least very similar (e.g., for ten possible products or users, each class may have a probability value of 0.1). With the initial weights, the neural network 710 is unable to determine low level features and thus cannot make an accurate determination of what the classification of the object might be. A loss function can be used to analyze errors in the output. Any suitable loss function definition can be used.

The loss (or error) can be high for the first training dataset (e.g., extracted coursework progression data) since the actual values will be different than the predicted output. The goal of training is to minimize the amount of loss so that the predicted output comports with a target or ideal output. The neural network 710 can perform a backward pass by determining which inputs (weights) most contributed to the loss of the neural network 710, and can adjust the weights so that the loss decreases and is eventually minimized.

A derivative of the loss with respect to the weights can be computed to determine the weights that contributed most to the loss of the neural network 710. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

The neural network 710 can include any suitable neural or deep learning network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, the neural network 710 can represent any other neural or deep learning network, such as an autoencoder, a deep belief nets (DBNs), a recurrent neural networks (RNNs), etc.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

1. A method for generating recommendations based on work log analyses, the method comprising;
collecting user data from a plurality of user devices over a communication network via a communication interface, wherein the user data includes employee work log data corresponding to logged time associated with one or more tasks, and wherein the employee work log data is designated as training data;
training a machine learning model via a neural network based on the training data, wherein the machine learning model is trained to identify one or more patterns of the training data, wherein the one or more patterns of the training data comprise time-based patterns associated with each of the tasks; and
executing instructions stored in memory via a processor, wherein the instructions are executed by the processor for:
adjusting one or more parameters of the machine learning model to minimize a difference between a predicted output and a target output of the training data;
receiving a request to analyze worklog data associated with a specified employee;
filtering work log data associated with the specified employee;
analyzing the filtered worklog data based on the trained machine learning model;
identifying one or more deviations from the patterns of the training data based on the analyzing of the filtered work log data, wherein the one or more deviations are identified based on a difference between the filtered worklog data and the training data and the difference that is determined to meet a predetermined threshold;
determining that a deviation of the one or more identified deviations corresponds with an improvement in work productivity of the specified employee; and
generating anomaly output regarding the identified one or more deviations including the deviation that corresponds with the improvement in the work productivity of the specified employee, and wherein the one or more identified deviations are identified from the time-based patterns associated with each of the tasks.

2. The method of claim 1, wherein the collected user data includes text-based descriptions of one or more tasks, and wherein machine learning model is trained to identify text-based patterns.

3. The method of claim 2, wherein the one or more identified deviations in the anomaly output include at least one deviation from the text-based patterns.

4.-7. (canceled)

8. The method of claim 1, wherein the anomaly output further includes a recommendation regarding the specified employee, and wherein the recommendation is based on the one or more identified deviations.

9. A non-transitory, computer-readable storage medium, having embodied thereon a program executable by a processor to perform a method for generating recommendations based on work log analyses, the method comprising;
collecting user data from a plurality of user devices over a communication network, wherein the user data includes employee work log data corresponding to logged time associated with one or more tasks, and wherein the employee work log data is designated as training data;
training a machine learning model based on the training data, wherein the machine learning model is trained to identify one or more patterns of the training data, wherein the one or more patterns of the training data comprise time-based patterns associated with each of the tasks;
adjusting one or more parameters of the machine learning model to minimize a difference between a predicted output and a target output of the training data;
receiving a request to analyze worklog data associated with a specified employee;
filtering worklog data associated with the specified employee;
analyzing the filtered worklog data based on the machine learning model;
identifying one or more deviations from the patterns of the training data based on the analyzing of the filtered worklog data, wherein the one or more deviations are identified based on a difference between the filtered worklog data and the training data and the difference that is determined to meet a predetermined threshold;
determining that a deviation of the one or more deviations corresponds with an improvement in work productivity of the specified employee; and
generating anomaly output regarding the identified one or more deviations including the deviation that corresponds with the improvement in the work productivity of the specified employee and wherein the identified one or more deviations are identified from the time-based patterns associated with each of the tasks.

10. The non-transitory, computer-readable storage medium of claim 9, wherein the collected user data includes text-based descriptions of one or more tasks, and wherein machine learning model is trained to identify text-based patterns.

11. The non-transitory, computer-readable storage medium of claim 10, wherein the one or more identified deviations in the anomaly output include at least one deviation from the text-based patterns.

12.-15. (canceled)

16. The non-transitory, computer-readable storage medium of claim 9, wherein the anomaly output includes a recommendation regarding the specified employee, and wherein the recommendation is based on the one or more identified deviations.

17. A system for generating recommendations based on work log analyses, the system comprising;
a database in memory that stores user data received from a plurality of user devices over a communication network, wherein the user data includes employee work log data corresponding to logged time associated with one or more tasks, and wherein the employee work log data is designated as training data;
a neural network that trains a machine learning model based on the training data, and adjusts one or more parameters of the machine learning model to minimize a difference between a predicted output and a target output of the training data, wherein the machine learning model is trained to identify one or more patterns of the training data, and wherein the one or more patterns of the training data comprise time-based patterns associated with each of the tasks;
a communication network interface that receives a request to analyze worklog data associated with a specified employee; and
a processor that executes instructions stored in memory, wherein the processor executes the instructions to:
filter worklog data associated with the specified employee;
analyze the filtered worklog data based on the machine learning model;
identify one or more deviations from the patterns of the training data based on the analyzing of the filtered worklog data, wherein the one or more deviations are identified based on a difference between the filtered worklog data and the training data and the difference that is determined to meet a predetermined threshold;
determine that a deviation of the one or more deviations corresponds with an improvement in work productivity of the specified employee; and
generate anomaly output regarding the identified one or more deviations including the deviation that corresponds with the improvement in the work productivity of the specified employee, and wherein the identified one or more deviations are identified from the time-based patterns associated with each of the tasks.

18. The method of claim 1, wherein the one or more deviations from the patterns of the training data are identified based on word frequency of the filtered worklog data.

19. The method of claim 1, wherein the one or more deviations from the patterns of the training data are identified based on sentence length of the filtered worklog data.

20. The method of claim 1, wherein the one or more deviations from the patterns of the training data are identified based on syntactic structure of the filtered worklog data.

21. The non-transitory, computer-readable storage medium of claim 9, wherein the one or more deviations from the patterns of the training data are identified based on word frequency of the filtered worklog data.

22. The non-transitory, computer-readable storage medium of claim 9, wherein the one or more deviations from the patterns of the training data are identified based on sentence length of the filtered worklog data.

23. The non-transitory, computer-readable storage medium of claim 9, wherein the one or more deviations from the patterns of the training data are identified based on syntactic structure of the filtered worklog data.

24. The system of claim 17, wherein the one or more deviations from the patterns of the training data are identified based on word frequency of the filtered worklog data.

25. The system of claim 17, wherein the one or more deviations from the patterns of the training data are identified based on sentence length of the filtered worklog data.

26. The system of claim 17, wherein the one or more deviations from the patterns of the training data are identified based on syntactic structure of the filtered worklog data.
